(19) United States
(12) Patent Application Publication
(10) Pub. No.: US 2015/0181266 A1
(43) Pub. Date: Jun. 25, 2015

(54) INHERITANCE BASE RIGHT OBJECT FILE GENERATION AND MANAGEMENT SCHEME IN A HOME SERVER

(71) Applicant: ARRIS Enterprises, Inc., Suwanee, GA (US)

(72) Inventors: Polly Tang, San Diego, CA (US); Steven Anderson, San Diego, CA (US); Rafie Shamsaasef, San Diego, CA (US)

(21) Appl. No.: 14/575,420

(22) Filed: Dec. 18, 2014

Related U.S. Application Data
(60) Provisional application No. 61/919,591, filed on Dec. 20, 2013.

(51) Int. Cl. H04N 21/254; H04N 21/258; H04N 21/4627; H04N 21/2747; H04N 21/41; G06F 17/30; H04N 21/266

(52) U.S. Cl. CPC H04N 21/2541; G06F 17/30858; G06F 17/3079; H04N 21/25816; H04N 21/266; H04N 21/2747; H04N 21/4135; H04N 21/4627

(57) ABSTRACT

A Digital Rights Management (DRM) system is provided to manage license rights for video object files where both parent and child object files are created. In the system a license library is provided, the license library including data identifying a parent object file allowing access to first video content and child object files relating to the parent object file also allowing access to the first video content. Further, the system creates a data tree structure with a parent pointer identifying the child object files related to the parent, and child pointers identifying the parent pointer related to the child. The data tree structure is used to modify the license library when a first request is received to modify one of the parent object files or the child object files. When a copy count is used and decremented when additional copies are made, the system updates the pointers in the data tree structure accordingly.

### CROSS REFERENCE TO RELATED APPLICATION

This Application claims priority under 35 U.S.C. §119(e) from earlier filed U.S. Provisional Application Ser. No. 61/919,591 filed on Dec. 20, 2013 and incorporated herein by reference in its entirety.

### BACKGROUND

1. Technical Field

The present invention relates to a Digital Rights Management (DRM) system to allow copying of video content to client devices under different license agreements.

2. Related Art

A first problem when managing digital rights for video media content with a DRM system is how to manage a DRM license (or Rights Object Files) associated with the same content but with different media formats. An Internet Protocol Rights Management (IPRM) library is required to manage the digital rights for contents recording from a Load On Demand (LOD) buffer (90 minutes circular recording buffer) and a Digital Video Recorder (DVR) recording for any channel that a client device using the IPRM library is tuned to. In addition, the IPRM library also has to handle the various transformed formats of the same piece of content. For example the transformed formant can be from an MP2 DVR recording to an MP4 transformed version of the DVR recording.

The followings formats (a)-(c) are a listing with details describing the three different format variations of right objects that may be used for the same content (say channel “ABC”).

(a) LOD: When a client device tunes to the channel ABC and watches without starting a DVR initiation, a temporary license will be created for the LOD buffer.

(b) DVR: When a client device is used to record a piece of content, either controlled to record when watching the ABC channel, or with the recording being a programmed event, a permanent license will be created for the DVR recording.

(c) Transcoded Content: Occurs when the video transmission platform automatically transcodes a piece of content, for example a DVR content for use on another client device or a stream/Sync&Go piece of DVR content provided to an iPad or Android tablet, or a streamed piece of LIVE content provided to the iPad or Android tablet.

The attributes in the above three forms of license have overlaps. The forms will need to be connected and related and managed the same way by the DRM system. An efficient way of finding an already existing license and copy over the overlap attributes to the new license, is desirable.

A second problem for a DRM system occurs when content service providers and DRM policies also have another requirement for video servers to share a fixed number of copies of the video content among all these licensees which have the same source ID (SourceID). This is a smaller scale of the first problem of domain right sharing: namely where all client devices under the same domain share the same rights, with the rights being total copy counts.

Note that the Digital Transmission Content Protection-Internet Protocol (DTCP-IP) standard form DRM has no domain concept, so rights sharing among DTCP conforming devices must be carefully managed.

A typical example where the second problem occurs may be when there are two copies of “ABC” which is a COG (copy one generation—that permits first-generation copying but prevents serial copying) content that has to be shared among a permanent DVR recording and a transcoded format provided to different client devices.

When the DTCP standard is used, in order to support the status change of license when a SyncNGo request to a COG content is made by the client, which is “MOVE” in DTCP protocol, the copy count must be taken into consideration along with the license right sharing considerations. For example, as soon as a piece of COG content is requested by the client and if the server has sufficient remaining copies to fulfill the request, a copy has to be locked/dedicated to the client. The IPRM library must have data accessible to be able to determine whether there is sufficient remaining copies to fulfill the request, and if the remaining copy is a shared entity among all licenses of the same SourceID.

It is desirable to provide a DRM system to handle copy count control under the second problem, as well as resolve license determine domain rights issues.

### SUMMARY

Embodiments of the present invention provide a Digital Rights Management (DRM) system to manage license rights for video object files where both parent and child object files are created. In the system a license library is provided, the license library including data identifying a parent object file allowing access to first video content and child object files relating to the parent object file also allowing access to the first video content. Further, the system creates a data tree structure with a parent pointer identifying the child object files related to the parent, and child pointers identifying the parent pointer related to the child. The data tree structure is used to modify the license library when a first request is received to modify one of the parent object files or the child object files. When a copy count is used and decremented when additional copies are made, the system updates the pointers in the data tree structure accordingly.

The DRM management system provides for changes to the IPRM library upon creation, modification and deletion of elements of the DRM management. These changes are described in the following paragraphs.

In the creation state, the platform middleware will first create a parent license and will use the parent license to generate a child license in the future whenever needed. A typical child license will inherit a few of the parent license attributes. The parent pointer in the child license will refer to the parent's filename as the parent pointer. The parent license will have to add the new child's full path to the list for its child pointer.

When a modification is made, such as by adding an in-home client device that can share the same video content, the number of remaining copy count in the entire family tree has to be decremented by 1. In this situation, the system walks through the family members and performs the updates. In case of a addition/deletion of any license in the tree family, the system will need to be able to walk through the family members of the tree. If the change starts from the parent, the parent license is able to find its child list and performs the update on the copy count on each child. On the other hand, if the change starts from a child member, the child member uses the parent pointer to locate the parent, and update the parent right object. The parent will then walk through the child list and update each child right object file. The walkthrough of the family members will further update the copy count status for each family member appropriately.

Should a delete of the parent license occur, the system will make 1^{st} child of the family become the parent of the family tree and the 2^{nd} child becomes the 1^{st} child of the child list. The update of the parent and child list of the family then proceeds under the modification description in the previous paragraph.

In one embodiment, to manage copy count a determination of remaining copy count is made to help insure that errors do not occur when copy count runs low. In this embodiment, a copy count evaluation value is determined by subtracting a new value for the original copy count from an existing value for the original copy count, and adding an existing remaining copy count. The copy count evaluation value can then be used to determine if additional copies are needed. In one embodiment, a preserve copy count flag is used and when the flag is false, the copy count cannot drop below zero, while when the flag is true the copy count cannot drop below one.

In a further embodiment, the system stores a remaining copy count balance count variable that operates independent of the copy count. The remaining copy count balance is decremented as copies are used along with the copy count. However, if the copy count freezes at a minimum value of 0 or −1 upon decrementing further, the remaining copy count balance continues to accurately show the more negative copy balance.

### BRIEF DESCRIPTION OF THE DRAWINGS

Further details of the present invention are explained with the help of the attached drawings in which:

FIG. 1 is a block diagram showing data structures that support the design of a parent and child licensing rights object file relationship that illustrates embodiments of the present invention;

FIGS. 2-3 show parent node and child note server side license data including code variables that provide for copy count and a family tree interrelation between parent and child nodes, FIG. 2 being a parent node and FIG. 3 being a child node; and

FIG. 4 shows a table illustrating values for the original copy count and possible remaining copy count changes when a change request is made to increment or decrement the original copy count.

### DETAILED DESCRIPTION

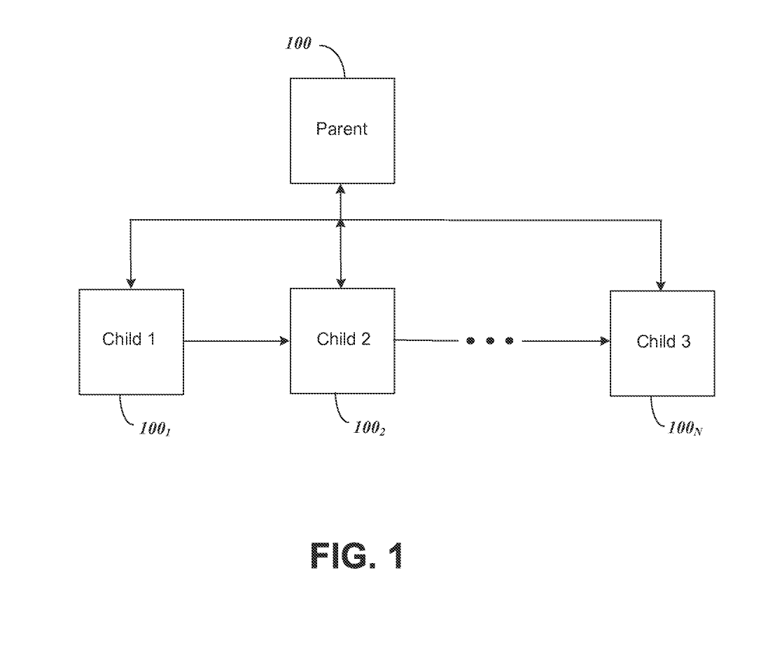

FIG. 1 is a block diagram showing data structures that support the design of a parent and child right object file relationship that illustrates embodiments of the present invention. FIG. 1 includes a Parent right object file 100 and it's relation to child object files, including Child 1 102₁, Child 2 102₂ . . . Child N 102_{N}. Note that there is a relation between the Parent file 100 and each of the Child files 102₁-102_{N}. Similarly, there is a relation between each successive pair of Child files 102₁-102_{N}.

In order to manage the licenses generated for a single piece of content that needs to handle all of the above object file relationships, embodiments of the present invention have introduced a tree data structure with the following attributes:

(a) a parent pointer;

(b) a list of child pointers; and

(c) a shared remaining copy counts of a piece of content among all nodes in the same family tree, wherein the parent child nodes are all included in the family tree.

### I. Stages for Managing Object Files

The right object file management scheme has to handle the different stages of the right object files, from creation to update/modification to eventually deletion. The different stages and their relation to the object file management scheme are described in the following paragraphs.

A. Creation Stage

Depending on the use case, for example whether a LOD or DVR comes first, the platform middleware of the DRM system of embodiments of this invention will first create a parent license and will use the parent license to generate a child license in the future whenever needed. A typical child license will inherit a few of the parent license attributes (refer to FIG. 3, all the * attributes described subsequently). A parent license is normally a LOD license or a DVR license. A child license could be either LOD license, DVR license or the Transcoded license, depending on the sequence of request of content.

The very first license created for a piece of content with say SourceID=“ABC” is a parent license of the content “ABC”. The parent license has to fill its own filename as the Parent pointer to indicate that it is the parent of the family. In the future, if there are other license to be created for SourceID=“ABC”, then the newer license will be a child to the parent license. The parent pointer in the child license will refer to the parent's filename as the parent pointer. Since a child license will not have another child (only one level of tree hierarchy is allowed), the list of child pointer in a child license is normally set to NULL. The parent license now has to add the new child's full path to the list of child pointer.

B. Update/Modification Stage

For the update/modification state the DRM system initially assumes a child license has been created from a parent, say for example the parent license is a DVR recording license and the child license is a Transcoded license of a piece of COG content. If there is a request to SyncNGo to either an In-Home client device or a remote client device, and if the system provider rules support that action request, the number of remaining copy count in the entire family tree has to be decremented by 1 by the DRM system, that is assuming that we will allow SyncNGo of 1 copy at a time. In this situation, the DRM system will need to be able to walk through the family members and perform the updates. In case of a addition/deletion of any license in the tree family, the DRM system will need to be able to walk through the family members of the tree. If the change starts from the parent, the parent license is able to find its child list and performs the update on the copy count on each child. On the other hand, if the change starts from a child member, the child member uses the parent pointer to locate the parent, and update the parent right object. The parent will then walk through the child list and update each child right object file.

Finally, IPRM also has an obligation to support DTCP, which requires IPRM to be able to keep track of status change of the licenses in the entire family tree. For example, as soon as a piece of COG content is requested by the client device and if the server has sufficient copies to fulfill the request, a copy has to be locked/dedicated to the client. And at this point there is a status change of the license to indicate the commitment/dedication to the client. This requires the DRM system of embodiments of the present invention to walk through the family members to update each status appropriately.

C. Deletion Stage

If there is a request to delete the parent license, the 1^{st} child of the family will become the parent of the family tree and all the 2^{nd} child becomes the 1^{st} child of the child list. The update of the parent and child list is identical to that in the update/modification stage.

### II. License Rights for Patent and Child

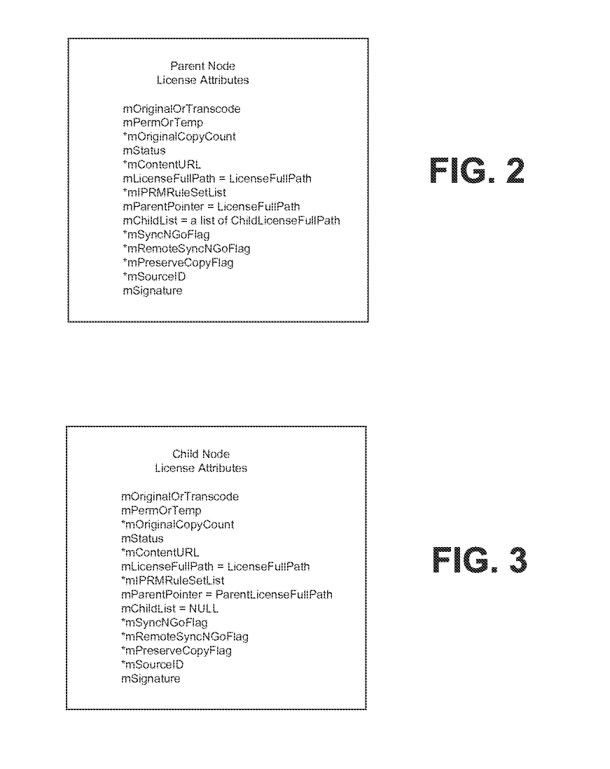

FIGS. 2-3 show parent node and child note server side license data including code variables that provide for copy count and a family tree interrelation between parent and child nodes. FIG. 2 shows the parent node variables, while FIG. 3 shows the child node variables. The asterisks “*” indicate variables that can be inherited by the child node from the parent node. For the family tree interrelation, the child nodes that relate to a particular parent node and sibling nodes can be located with the variable mChildList. The parent node can be located using the variable mParentPointer.

For copy count determination for related parent and child nodes the location of the parent and child are used to update the copy count using the variable mRemainingCopyCount that is shared with the entire family that is incremented and decremented who copies are added or removed. To control copy count, the additional variable mOriginalCopyCount tells the initial copies available and the variable mPreserveCopyFlag is provided to indicate when no further copies are available.

The variable mSignature allows a signature to be provided for authentication purposes for the license rights for the parent and child nodes. Other variables like mStatus that provides an operation status and mSyncNGoFlag that enables synchronization are self explanatory.

### III. Management of Restriction List Including Copy Count

Updates to the restriction values include updating the Initial Copy Count, Remaining Copy Count and more. Updating the restriction list is done by using the Internet Protocol Rights Management Application Programming Interface (IPRM API) labeled IPRM_UpdateRestrictionData( ). Implementation of this API allows modification to restriction values, including decrementing and increasing of the copy count.

A. Proposal No. 1 to Update Restriction Values

In one example if the Internet Management Guide (IMG), the IMG controlling assignment of license rights to the parent and servers, wants to “call back” or reduce the original copy count from 5 to 4, and if the current remaining count=0, then the related parent-child system is short 1 copy after the decrement. Accordingly in a first embodiment it is proposed that the system will first warn the IMG that it is short 1 copy as a Return Error and suggest that the IMG first check-in a further copy from a client before proceeding with the decrement copy count request.

For this proposal, a check is further performed to determine if the copies remaining are adequate if the copy count is reduced. In one example, depending on a preserveCopyCount value which tells if the copy count is zero or if it is higher, the following equations are applied:

If (preserveCopyCount==false)

(New_value_of_Original_Copy_Count−Existing_value_of_Original_Copy_Count)+Existing_Remaining_Copy_Count>=0 then the remaining copy count is OK, otherwise it is not OK.

If (preserveCopyCount==true)

(New_value_of_Original_Copy_Count−Existing_value_of_Original₁₃ Copy_Count)+Existing_Remaining_Copy_Count>=1 then the remaining copy count is OK, otherwise it is not OK.

If the result is not ok, then the system gives out a warning to a Software Development Kit (SDK) to check-in with the IMG the number of copies that are needed. Ensuring that the number of copies are adequate will prevent database errors.

B. Proposal No. 2 to Update Restriction Values

In some circumstances the IMG can ask for a reduction more than once, or the IMG could ask for a reduction followed by an increment. Accordingly, this embodiment proposes addition of an additional bit field which is balanceRemainingCount that starts at 0 initially. If the system is short 1 copy, a −1 goes into the balanceRemainingCount. This balanceRemainingCount is only altered when a UpdateRestrictionList API is called.

When there are check-ins to the IMG, a process using the balanceRemainingCount will handle accounting for the balanceRemainingCount as it goes more negative. If there are enough check-ins events that make the balanceRemainingCount go back to 0, then the system can start incrementing the remainingCopyCount to a bigger number and the balanceRemainingCount will be not likely be needed.

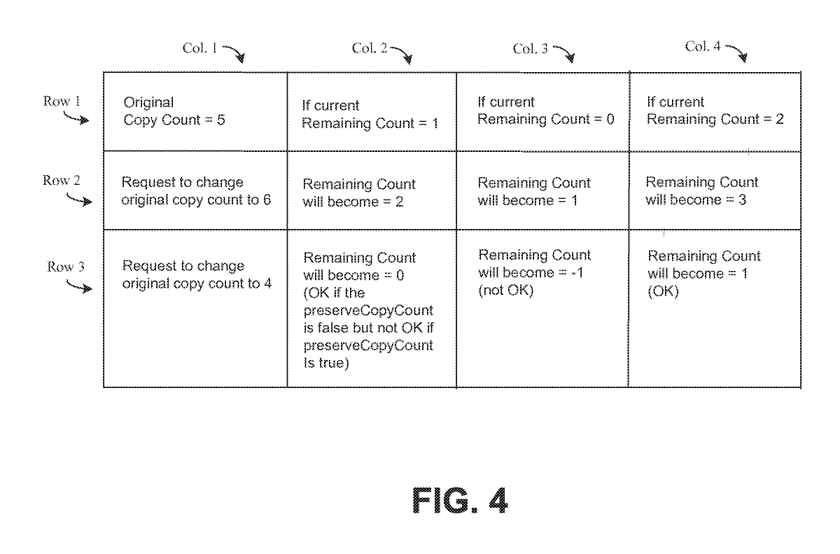

It is up to the IMG to callback the number of copies that the system is short based on the balanceRemainingCount value. This method will also allow as many changes to the original copy count as needed. The table of FIG. 4 illustrates values for the Original_Copy_Count and possible Remaining_Copy_Count changes when a change request is made to increment or decrement the Original_Copy_Count.

In the table of FIG. 4, row 1 column 1, indicates the original copy count is 5. The rows 2-3 in column 1 indicate that a request has been made to either increment the original copy count from 5 to 6 in row 2, or decrement the copy count from 5 to 4 in row 3. The columns 2-4 of row 1 indicate that the current remaining count is 1, 0 or 2 respectively. The columns 2-4 of rows 2 and 3 then indicate what the remaining count will be with such that: (1) in row 2 the remaining count is considered upon incrementing copy count with the different current remaining count values; and (2) in row 3 the remaining count is considered upon decrementing copy count with the different remaining count values, along with the consequences of remaining count values.

To go further than the table of FIG. 4, to illustrate when the new variable balanceRemainingCount is needed, a further example is provided. In this further example, if the original copy count has to goes down from 5 to 4 and the current remaining copy count is=−1, the remaining count will change to −2.

The balance below −1 creates an error, and the system may not further tabulate more negative values, necessitating the balanceRemainingCount attribute variable. This extra attribute balanceRemainingCount, is available to keep track of the negative count due to update or change to the original copy count. This balanceRemainingCount will let us know how many copies are in surplus or arrears without messing up the current Remaining Count in IPRM_EstablishSessionForLicensedContent, even if that value will not drop below −1.

For components shown in the figures, such as the parent right object file 100 and child right object file 102 shown in FIG. 1, it is understood that these can be stored in a memory and accessed by a DRM system that includes one or more processors and memory components. The memory can be made from devices will store code that is executable by the processors to perform the methods and DRM system modules according to the present invention described in the above paragraphs. The memory can be loaded from a computer readable medium, such as a DVD or cloud storage over the internet.

Although the present invention has been described above with particularity, this was merely to teach one of ordinary skill in the art how to make and use the invention. Many additional modifications will fall within the scope of the invention as that scope is defined by the following claims.

What is claimed:

1. A Digital Rights Management (DRM) method comprising:
providing a license library, the license library including data identifying a parent object file allowing access to first video content and child object files relating to the parent object file allowing access to the first video content;
providing a data tree structure comprising:
a parent pointer identifying the child object files;
child pointers identifying the parent pointer;
using the data tree structure to modify the license library when a first request is received to modify one of the parent object files or the child object files.

2. The DRM method of claim 1,
wherein the step of providing a data tree structure further comprises providing a copy count number for the first video content, wherein the copy count is separately provided for each of the parent object files and the child object files; and
wherein the step of using the data tree structure comprises changing the copy count for each of the parent object files and the child object files when the copy count is decremented to add a new child object file.

3. The DRM method of claim 1, further comprising:
modifying the license library to make one of the child object files the new parent file when a request is received to delete the parent file.

4. The DRM method of claim 1, wherein the parent object files and the child object files identify an entity comprising at least one of:
(a) a Load on Demand (LOD) recording buffer;
(b) a Digital Video Recorder; and
(c) a transcoded file that is streamed to a device that includes at least one of a tablet computer, a cell phone and a personal computer.

5. The DRM method of claim 2, wherein when the copy count is decremented, the method further comprises:
subtracting a new value for the original copy count from an existing value for the original copy count, and adding an existing remaining copy count to provide a copy evaluation value; and
using the copy evaluation value to determine if additional copies are needed.

6. The DRM method of claim 5,
wherein when a preserve copy count flag is false, the copy evaluation value being less than zero indicates that additional copies are needed, and
wherein when a preserve copy count flag is true, the copy evaluation value being less than one indicates that additional copies are needed.

7. The DRM method of claim 5, further comprising:
determining the remaining copy count balance count that initially starts at zero and will provide an accurate copy count balance remaining even after the copy count goes below −1.

8. A Digital Rights Management (DRM) system server comprising a processor and a first memory storing code that is executable by the processor, the code being executable to cause the processor form modules for performing processing functions, and the system server further comprising a second memory for storing data that is accessed by the processor,
wherein the second memory stores a license library, the license library including data identifying a parent object file allowing access to first video content and child object files relating to the parent object file allowing access to the first video content;
wherein the second memory further stores a data tree structure comprising:
a parent pointer identifying the child object files;
child pointers identifying the parent pointer, and
wherein the first memory code causes the processor to access the data tree structure in the first memory and to modify the license library when a first request is received to modify one of the parent object files or the child object files.

9. The DRM system server of claim 8,
wherein the data tree structure further comprises a copy count number for the first video content, wherein the copy count is separately provided for each of the parent object files and the child object files; and
wherein the first memory code further causes the processor to access the data tree structure to change for each of the parent object files and the child object files when the copy count is decremented to add a new child object file.

10. The DRM system server of claim 8, further comprising:
wherein the first memory code further causes the processor to access the data tree structure to modify the license library to make one of the child object files the new parent file when a request is received to delete the parent file.

11. The DRM system server of claim 8, wherein the parent object files and the child object files identify an entity comprising at least one of:
(a) a Load on Demand (LOD) recording buffer;
(b) a Digital Video Recorder; and
(c) a transcoded file that is streamed to a device that includes at least one of a tablet computer, a cell phone and a personal computer.

12. The DRM system server of claim 9, wherein when the copy count is decremented, the first memory code further causes the processor to access the data tree structure to:
subtract a new value for the original copy count from an existing value for the original copy count, and add an existing remaining copy count to provide a copy evaluation value that is stored in the second memory; and
use the copy evaluation value to determine if additional copies are needed.

13. The DRM system server of claim 12, wherein the second memory further stores a preserve copy count flag, and
wherein when a preserve copy count flag is false, the first memory code further causes the processor to determine if the copy evaluation value is less than zero and when so indicate that additional copies are needed, and
wherein when a preserve copy count flag is true, the first memory code further causes the processor to determine if the copy evaluation value is less than one and when so indicate that additional copies are needed.

14. The DRM system server of claim 12, wherein the first memory code further causes the processor to store the remaining copy count balance count into the second memory so that it initially starts at zero and provides an accurate copy count balance remaining even after the copy count goes below −1.
